(19) United States
(12) Patent Application Publication
(10) Pub. No.: US 2016/0377279 A1
(43) Pub. Date: Dec. 29, 2016

(54) REPLACEABLE OPTICAL MODULE LAMP

(71) Applicant: Lediamond Opto Corporation, New Taipei City (TW)

(72) Inventors: Peng-Yu CHEN, New Taipei City (TW); Chung-Ting TSENG, New Taipei City (TW); Hsuan-Hsien LEE, New Taipei City (TW)

(21) Appl. No.: 14/974,316

(22) Filed: Dec. 18, 2015

(30) Foreign Application Priority Data
Jun. 24, 2015 (TW) 104210141

(51) Int. Cl. F21V 31/00; F21K 99/00

(52) U.S. Cl. CPC F21V 31/005; F21K 9/30

(57) ABSTRACT

A replaceable optical module lamp includes a light-emitting module, a circuit board, a sealing layer, and an optical module. The circuit board and the light-emitting module are electrically connected to each other. The sealing layer encloses the light-emitting module and the circuit board and includes a first assembling structure. The optical module is assembled to the sealing layer and is provided with an assembling hole. The assembling hole of the optical module is surroundingly connected to the sealing layer, so that the light-emitting module is disposed in the optical module. The optical module is provided with a second assembling structure detachably assembled to the first assembling structure to facilitate replacement. Accordingly, cost is reduced, and the optical module can be replaced with ease.

### TECHNICAL FIELD

The present invention relates to a lamp and, in particular, to a replaceable optical module lamp which enables easy replacement of an optical module.

### BACKGROUND

A conventional lamp, such as a display lamp or a projection lamp, usually includes an external member and a light-emitting assembly disposed in the external member. The light-emitting assembly includes a circuit board and a plurality of light-emitting units electrically disposed on the circuit board. The external member includes an optical structure and a metal lamp base (or glass lamp base) inseparable therefrom. The metal lamp base is utilized in an LED lamp, and the glass lamp base is utilized in a traditional lamp.

In order to comply with the safety regulations, the light-emitting assembly has to be enclosed by a covering layer to prevent inadvertent touch by a user's hands or fingers.

Therefore, a required lamp is so constructed that the light emitted from the light-emitting assembly is reflected by a reflector to achieve an illumination effect as desired.

The illumination/reflection requirement varies depending on users or environments, but the optical structure cannot be separated from the metal lamp base (or the glass lamp base) of the conventional lamp. This impedes convenient replacement of the reflector. To replace the reflector, the metal lamp base (or glass lamp base) also has to be replaced too, which causes a waste of material and cost.

Accordingly, the inventor aims to overcome the above-mentioned problems, on the basis of which the present invention is accomplished.

### SUMMARY

It is an object of the present invention to provide a replaceable optical module lamp which reduces cost and enables convenient replacement of an optical module (e.g. an optical lens or a reflector).

Accordingly, the present invention provides a replaceable optical module lamp. The replaceable optical module lamp comprises a light-emitting module, a circuit board connected to the light-emitting module, a sealing layer enclosing the light-emitting module and the circuit board and including a first assembling structure, and an optical module assembled to the sealing layer and provided with an assembling hole. The assembling hole of the optical module is surroundingly connected to the sealing layer, the light-emitting module is disposed in the optical module, the optical module is provided with a second assembling structure detachably assembled to the first assembling structure to facilitate replacement.

Compared with the conventional techniques, the present invention has the following effects. An inexpensive sealing base is substituted for the expensive metal lamp base, or a high strength sealing base is substituted for the fragile glass lamp base, thereby reducing costs, improving structural strength, and enabling convenient replacement of the optical module.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective exploded view of a light-emitting module of a lamp according to a first embodiment of the present invention;

FIG. 2 is a schematic view of the present invention, illustrating FIG. 1 enclosed by a sealing body;

FIG. 3 is a partial cross-sectional view of the present invention based on FIG. 2;

FIG. 4 is a cross-sectional view of the present invention, illustrating FIG. 3 further enclosed by a sealing base;

FIG. 5 is a perspective exploded view of the lamp according to the first embodiment of the present invention;

FIG. 6 is a perspective assembled view of the lamp according to the first embodiment of the present invention;

FIG. 7 is a cross-sectional view of the lamp of the present invention, illustrating that the first assembling structure is interference fit with the second assembling structure;

FIG. 8 is a cross-sectional view of the lamp of the present invention, illustrating that the first assembling structure is threadedly connected to the second assembling structure; and

FIG. 9 is a cross-sectional view of the lamp of the present invention, illustrating an integral-type sealing layer.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

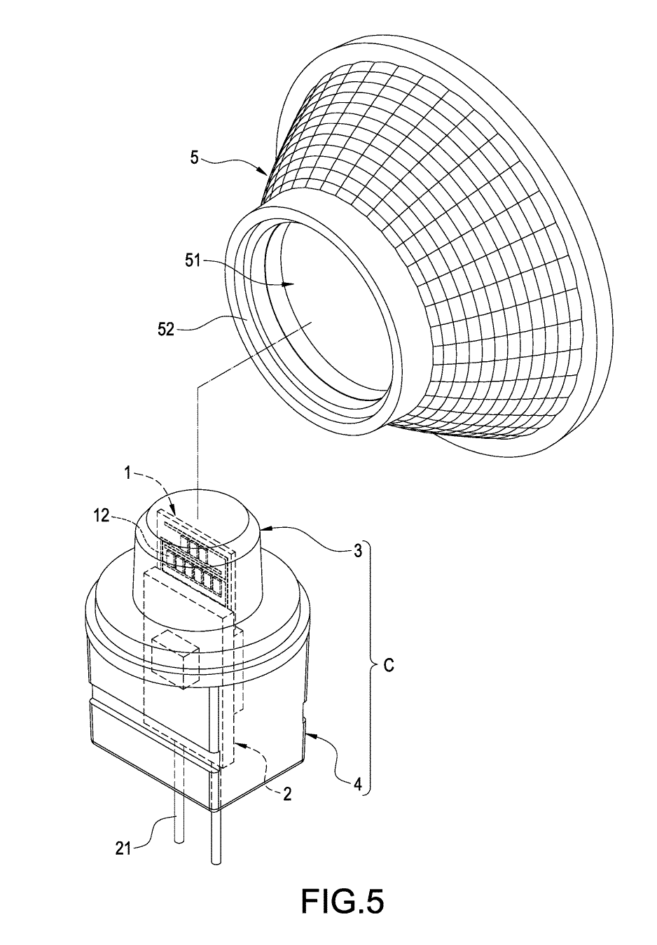

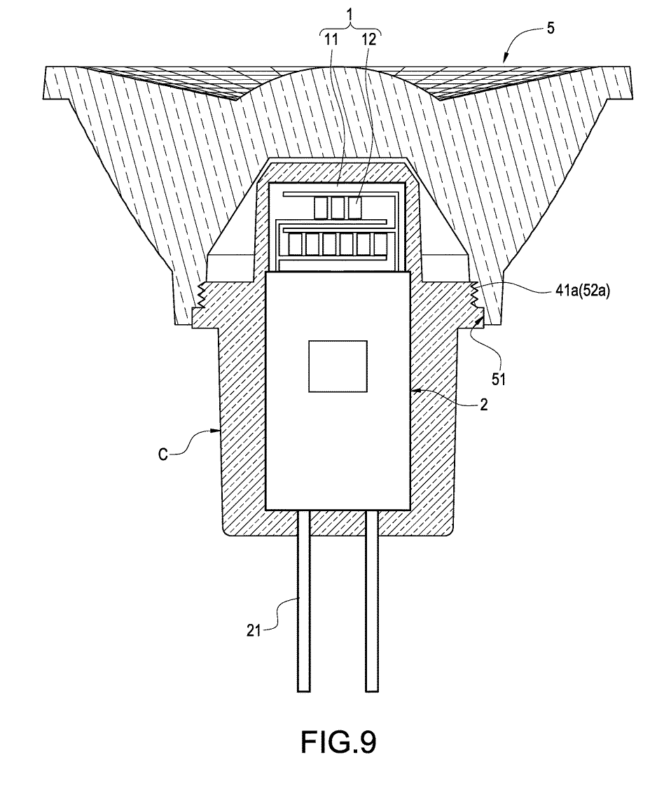

The present invention provides a replaceable optical module lamp. The replaceable optical module lamp includes but is not limited to a display lamp, a projection lamp, or etc. The present embodiment is described by taking the projection lamp as an example. As shown in FIG. 5 or FIG. 9, the lamp of the present invention includes a light-emitting module 1, a circuit board 2, a sealing layer C and an optical module 5.

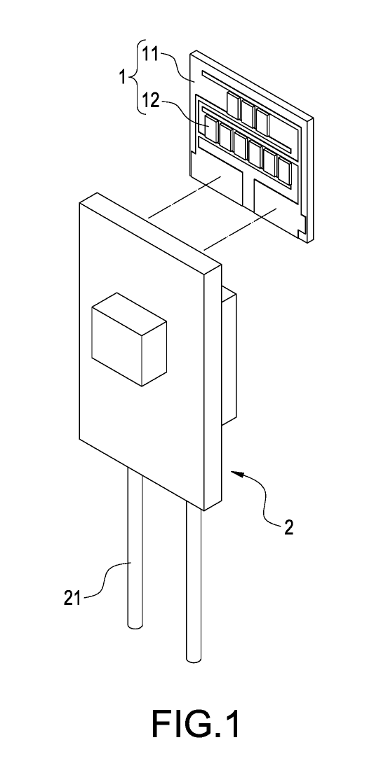

Please refer to FIGS. 1, 2, and 3 which show a first embodiment of the present invention. The light-emitting module 1 includes a carrier 11 and a plurality of light-emitting elements 12. Each of the light-emitting elements 12 is electrically disposed on the carrier 11. The light-emitting elements 12 can be various types of suitable luminous elements. In the present embodiment, the light-emitting element 12 is described by taking a light-emitting diode (LED) as an example. The carrier 11 can be a light-transparent plate. The light-emitting element 12 needs only to be disposed one side of the light-transparent carrier 11, thereby permitting light emission from the other side of the carrier 11 so as to achieve omnidirectional illumination. In other words, less light-emitting elements 12 and less power are required to achieve omnidirectional illumination, thereby reducing costs, saving power, and achieving high efficiency.

The circuit board 2 is electrically connected to the light-emitting module 1. To be specific, the light-emitting module 1 is electrically connected to the circuit board 2 via the carrier 11. The light-emitting module 1 is protruding from the circuit board 2. Furthermore, a plurality of leads 21 are electrically connected to the circuit board 2, and each of the leads 21 protrudes from the circuit board 2.

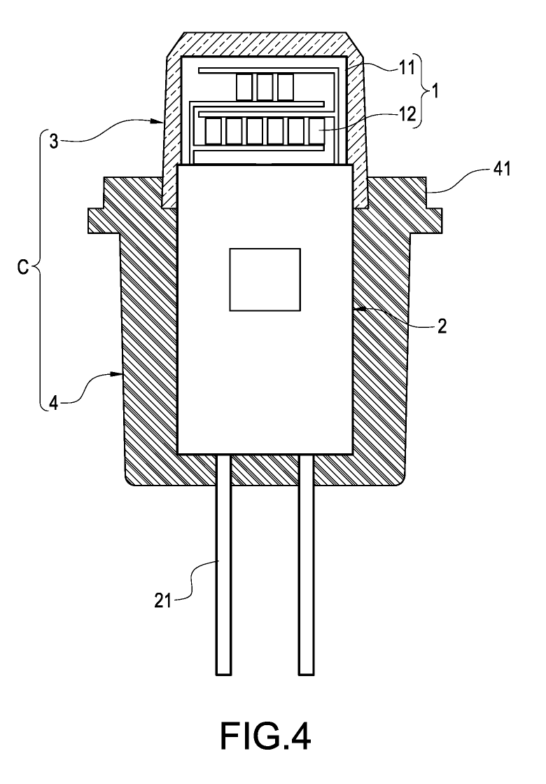

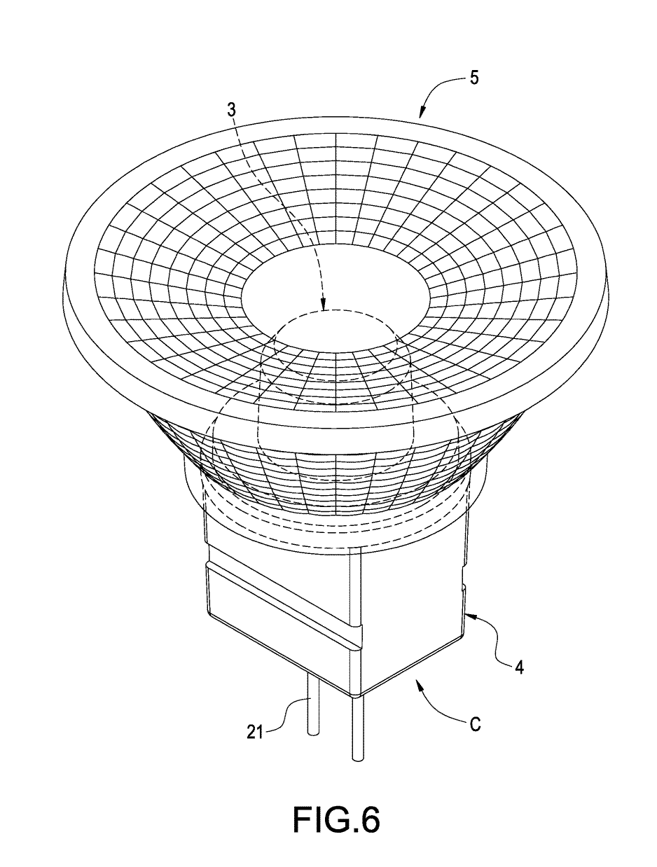

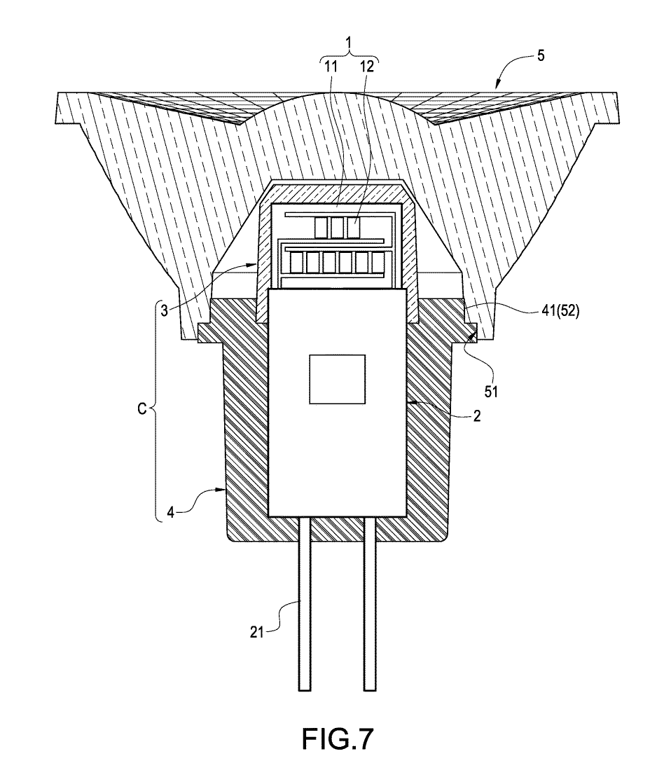

The sealing layer C can be a plurality of connected bodies (as shown in FIGS. 4 to 8) or an integrally formed body (as shown in FIG. 9). In the present embodiment, the description takes as an example a case where the sealing layer C includes a sealing body 3 and a sealing base 4.

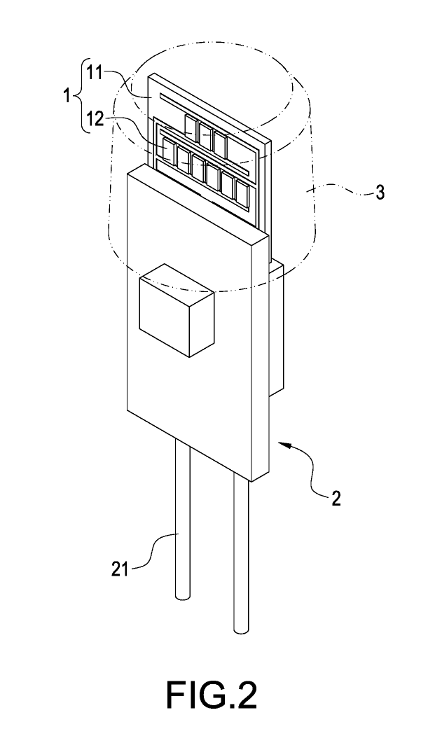

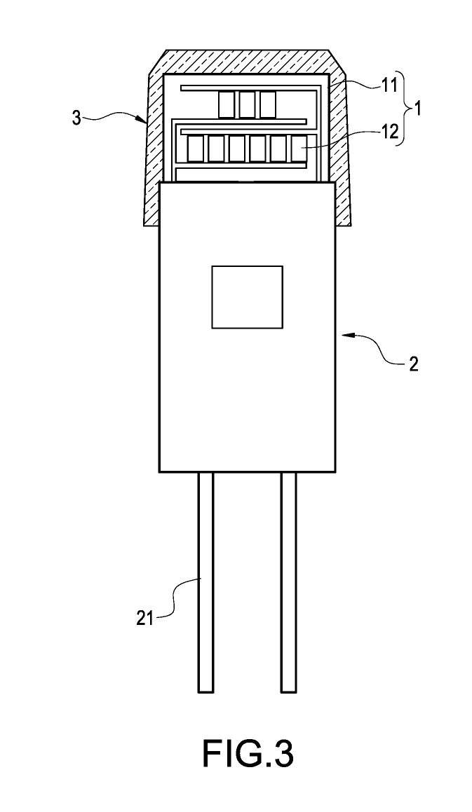

The above-mentioned light-emitting module 1 itself can be enclosed by a protection layer (not illustrated) to prevent inadvertent touch by a user's fingers or hands. In the present embodiment, the light-emitting module 1 is enclosed by the sealing body 3 (see FIGS. 2 and 3), and it is preferable that the sealing body 3 also covers the circuit board 2.

Referring to FIGS. 4, 5, and 6, the sealing base 4 encloses the circuit board 2. After enclosure, the light-emitting module 1 and each of the leads 21 are exposed and protrude from the sealing base 4, and the sealing base 4 also encloses at least a portion of the sealing body 3 (see FIG. 4). To be specific, a portion of the sealing body 3 is embedded in the sealing base 4, so as to be firmly and fixedly fastened to each other.

The sealing base 4 includes a first assembling structure 41. In the present embodiment, the description is made by taking as an example a case where the first assembling structure 41 is disposed on an outer periphery of the sealing base 4.

The optical module 5 is assembled to the sealing base 4. The optical module 5 is provided with an assembling hole 51. A second assembling structure 52 is disposed corresponding to an inner periphery of the assembling hole 51. The second assembling structure 52 is corresponding to the first assembling structure 41, and the first assembling structure 41 and the second assembling structure 52 are detachably assembled to each other. The optical module 5 can be at least one optical lens or a reflector. In the present embodiment, the description is made by taking the optical lens as an example.

The assembling hole 51 of the optical module 5 is surroundingly connected to the sealing base 4, so that the light-emitting module 1 is disposed between the optical module 5 and the sealing base 4, and the second assembling structure 52 is detachably assembled to the first assembling structure 41 of the sealing base 4. Therefore, the optical module 5 can be detached from the sealing base 4 as desired, thereby facilitating convenient replacement of the optical module 5.

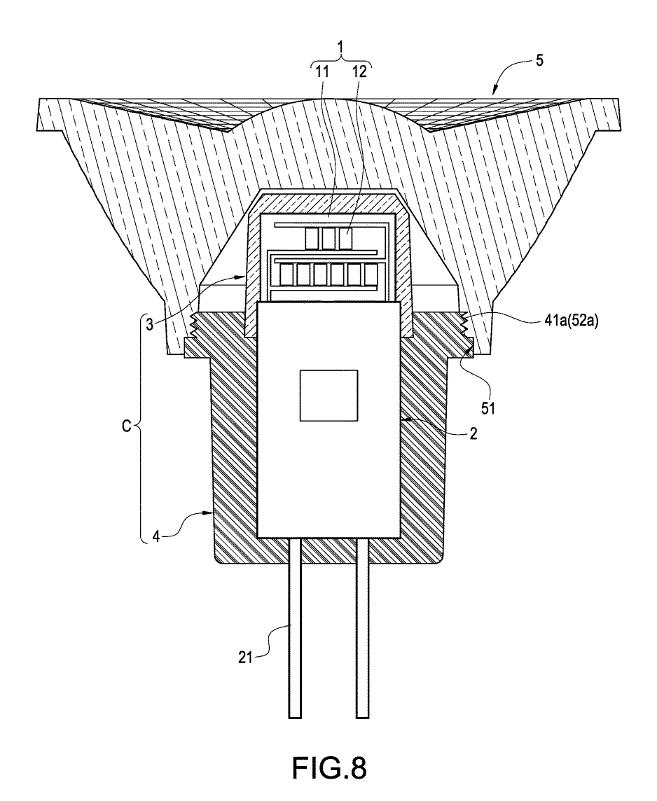

The first assembling structure 41 and the second assembling structure 52 can take various forms, as shown in FIGS. 5, 6, and 7. In the present embodiment (the first embodiment), the description is made by taking as an example a case where the first assembling structure 41 is assembled to the second assembling structure 52 by forming an interference fit with each other. Certainly, the assembling can also be achieved by making a threaded connection (see a second embodiment shown in FIG. 8) therebetween, so that the first assembling structure 41a having an external thread is detachably threadedly connected to the second assembling structure 52a having an internal thread. Alternatively, the assembling can be achieved by engagement (not illustrated), so as to enable detachable engagement to each other. In other words, the first assembling structure and the second assembling structure can be assembled together in any suitable way which can enable detachable assembling therebetween, and the present invention is not limited in this regard.

Referring to FIG. 9 which shows a third embodiment of the present invention, the third embodiment is similar to the above-mentioned first or second embodiment, and the only difference therefrom resides in the sealing layer C.

The sealing layer C in the third embodiment is an integral body to enclose the light-emitting module 1 and the circuit board 2 at the same time. The sealing layer C includes the above-mentioned first assembling structure 41(41a). The assembling hole 51 of the optical module 5 is surroudingly connected to the sealing layer C, so that the light-emitting module 1 is disposed in the optical module 5, and the second assembling structure 52(52a) of the optical module 5 is detachably assembled to the first assembling structure 41(41a) of the sealing layer C to facilitate replacement.

In summary, compared with conventional techniques, the present invention has the following effects. By utilizing the sealing layer C to enclose both the optical module 1 and the circuit board 2 (like the third embodiment of the present invention), or by utilizing the sealing base 4 to enclose the circuit board 2 and combining the optical module 1 and the circuit board 2 together (like the first and second embodiments of the present invention), an inexpensive sealant (i.e. the sealing layer C or the sealing base 4) is substituted for an expensive metal lamp base in a conventional lamp (see the “Background” section), or the high strength sealant (i.e. the sealing layer C or the sealing base 4) is substituted for a fragile glass lamp base in the conventional lamp, thereby reducing costs and improving structural strength. Furthermore, the optical module 5 is detachably assembled to the sealing base 4, so different optical modules 5 can be exchanged as required by users or environment, thereby enabling replacement/exchange of the optical module 5. Moreover, the carrier 11 can be a light-transparent plate, so less light-emitting elements 12 and less power are required to achieve omnidirectional illumination, thereby reducing costs, saving power, and achieving high efficiency.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A replaceable optical module lamp, comprising:
a light-emitting module;
a circuit board electrically connected to the light-emitting module;
a sealing layer enclosing the light-emitting module and the circuit board and including a first assembling structure; and
an optical module assembled to the sealing layer and provided with an assembling hole, the assembling hole of the optical module being surroundingly connected to the sealing layer, the light-emitting module being disposed in the optical module, the optical module being provided with a second assembling structure detachably assembled to the first assembling structure to facilitate replacement.

2. The replaceable optical module lamp of claim 1, wherein the second assembling structure is disposed in the optical module and corresponding to the assembling hole.

3. The replaceable optical module lamp of claim 1, wherein the first assembling structure is interference fit with the second assembling structure.

4. The replaceable optical module lamp of claim 1, wherein the first assembling structure is threadedly connected to the second assembling structure.

5. The replaceable optical module lamp of claim 1, wherein the first assembling structure and the second assembling structure are engaged with each other.

6. The replaceable optical module lamp of claim 1, wherein the sealing layer includes a sealing base enclosing the circuit board, the light-emitting module is exposed from the sealing base, the sealing base includes the first assembling structure, and the second assembling structure of the optical module is detachably assembled to the first assembling structure of the sealing base.

7. The replaceable optical module lamp of claim 6, wherein the assembling hole of the optical module is surroundingly connected to the sealing base, and the light-emitting module is disposed between the optical module and the sealing base.

8. The replaceable optical module lamp of claim 6, wherein the sealing layer further includes a sealing body, and the sealing body encloses the light-emitting module.

9. The replaceable optical module lamp of claim 8, wherein the sealing base encloses a portion of the sealing body.

10. The replaceable optical module lamp of claim 1, wherein the light-emitting module includes a carrier and a plurality of light-emitting elements electrically disposed on the carrier, and the light-emitting module is electrically connected to the circuit board via the carrier.

11. The replaceable optical module lamp of claim 1, further comprising a plurality of leads, each of the leads being electrically connected to the circuit board and protruding out of the sealing layer.
